(19) United States
(12) Patent Application Publication
(10) Pub. No.: US 2021/0396383 A1
(43) Pub. Date: Dec. 23, 2021

(54) GERM PROTECTOR FOR CAKES AND DESSERTS

(71) Applicant: Brian Fuge, Stonybrook, NY (US)

(72) Inventor: Brian Fuge, Stonybrook, NY (US)

(21) Appl. No.: 17/341,959

(22) Filed: Jun. 8, 2021

Related U.S. Application Data
(60) Provisional application No. 63/042,430, filed on Jun. 22, 2020.

(51) Int. Cl. F21V 35/00; A47G 19/26

(52) U.S. Cl. CPC F21V 35/00; A47G 2400/061; A47G 2400/02; A47G 19/26

(57) ABSTRACT

A cover for a food item includes a sidewall and a top. The cover is made of a plastic material that is at least one of rigid, transparent, fire retardant, and dishwasher safe. The top is integrally coupled to the sidewall and together with the sidewall forms an interior space to enclose the food item located therein. The top comprises an upper surface having a feature configured to secure a candle to the top. The feature is at least one of a recess and a protrusion. The cover is configured to protect the food item from airborne contamination released by a person while blowing out the candle.

### CROSS REFERENCE TO RELATED APPLICATION

This application claims the benefit of U.S. Provisional Application No. 63/042,430 filed on Jun. 22, 2020. The above identified patent application is herein incorporated by reference in its entirety.

### TECHNICAL FIELD

The present disclosure relates generally to a cover for special occasion food items, such as desserts, and more preferably, cakes.

### BACKGROUND

During special occasions, such as birthdays. one or more candles are often inserted into a top of a cake or dessert. Generally, the one or more candles are lit and are then blown out by a person to whom the cake or dessert, in which the one or more candles are inserted, is presented. When the person blows out the one or more candles, droplets of saliva are likely to be sprayed on the top surface of the cake. Importantly, these droplets may include germs, bacteria, viruses, such as the COVID-19 virus, and other disease carrying particles. In other words, the person blowing out the candles creates airborne contamination that may settle on the top surface of the cake. Once the contaminated cake has been sliced, the people consuming the cake slices may become infected.

Accordingly, there is a need for a cover that is capable of holding one or more lighted candles on the top surface of the cover, while protecting the food item, e.g., a cake, inside from airborne contaminants released by the person blowing out the one or more lighted candles.

### SUMMARY

A germ protector (i.e., a cover) for food items, such as cakes or desserts, is designed to stop the transmission of human fluid droplets and airborne contaminants to an upper surface of the cake or dessert. The germ protector, however, may be used to cover any food item, with the cake or dessert being preferable. The food item, e.g., cake, may be of any shape, such as circle, square, or rectangle.

The cover includes features that allow insertion of candles into the top of the cover. In one embodiment, an upper surface of the cover includes one or more recesses or dimples for holding candles, allowing insertion of the candles into the recesses or dimples.

In one embodiment, a cover for a food item is disclosed. The cover includes a sidewall and a top. The top is integrally coupled to the sidewall and together with the sidewall forms an interior space to enclose the food item located therein. The top comprises an upper surface having a feature to secure a candle to the top. The cover is configured to protect the food item from airborne contamination released by a person while blowing out the candle.

In another embodiment, a cover is disclosed that includes a curved wall forming an interior space to enclose the food item located therein. The curved wall comprising an upper surface having a feature to secure a candle to the upper surface. The cover is configured to protect the food item from airborne contamination released by a person while blowing out the candle.

In yet another embodiment, a food-item enclosure is disclosed. The food-item enclosure includes a cover and a base. The base is configured to support a food item. The cover is positioned on top of the base. The cover comprises a top that is integrally coupled to a sidewall and together with the base forms an interior space configured to fully enclose the food item located on the base. The top comprises an upper surface having one or more features to secure one or more candles to the top. In some embodiments, the cover is made of a plastic material that is at least one of substantially rigid, transparent, fire retardant, and dishwasher safe property. The cover is configured to protect the food item from airborne contamination released by a person while blowing out the one or more candles.

In some examples, the feature to secure one or more candles to the top of the cover is at least one of a recess and a protrusion.

In some examples, the feature to secure one or more candles to the top of the cover has at least one of a circular shape and a rectangular shape.

In some examples, the candle is secured on the top of the cover by way of a candle adaptor having a bottom portion to engage with the feature on the upper surface of the top of the cover, and a top portion to receive the candle.

In some examples, the sidewall of the cover includes an at least one member configured to be grasped during manual lifting and lowering of the cover. In some examples, the at least one member is one of a recess, a protrusion, and a handle.

In some examples, the top of the cover includes an at least one member configured to be grasped during manual lifting and lowering of the cover. In some examples, the at least one member is one of a recess, a protrusion, and a handle.

Various embodiments of the present disclosure provide a cover preferably made of a plastic material that is at least one of substantially rigid, transparent, fire retardant, and dishwasher safe. The cover together with a base, forms an interior space to enclose the food item supported by the base. The cover has one or more features to secure one or more candles to a top of the cover. The one or more features are at least one of a recess and a protrusion. The cover is configured to protect, the food item from airborne contamination released by a person while blowing out the one or more candles. Once the cover, with the one or more candles inserted therein, is placed over the food item, such as a special occasion cake or dessert, and the one or more candles are lit, the person to whom the cake is presented may blow out the one or more candles without contaminating the cake. Thus, with the cover in place, while blowing out the one or more candles, the surface of the cake is protected from being sprayed with germs, viruses, such as the COVID-19 virus, or bacteria, and the people consuming the cake are protected from being infected.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

FIG. 1A is a top view of a cover for a food item in accordance with an embodiment of the invention;

FIG. 1B is a perspective view of the cover of FIG. 1A in accordance with an embodiment of the invention;

FIG. 1C is a front view of a food-item enclosure including the cover of FIG. 1A and a base in accordance with an embodiment of the invention;

FIG. 2A is a diagram illustrating a candle secured to a top of the cover of FIG. 1A in accordance with an embodiment of the invention;

FIG. 2B is a diagram illustrating the candle secured to the top of the cover of FIG. 1A in accordance with another embodiment of the invention;

FIG. 2C is a diagram illustrating the candle secured to the top of the cover of FIG. 1A by way of a candle adaptor in accordance with another embodiment of the invention;

FIG. 3A is a top view of a cover for a food item in accordance with another embodiment of the invention;

FIG. 3B is a perspective view of the cover of FIG. 3A in accordance with another embodiment of the invention;

FIG. 3C is a front view of a food-item enclosure including the cover of FIG. 3A and a base in accordance with another embodiment of the invention;

FIG. 4A is a top view of a cover for a food item including a member to be grasped for manual lifting or lowering of the cover in accordance with an embodiment of the invention;

FIG. 4B is a perspective view of the cover of FIG. 4A including the member to be grasped for manual lifting or lowering of the cover in accordance with an embodiment of the invention:

FIG. 5A is a top view of a cover for a food item in accordance with yet another embodiment of the invention;

FIG. 5B is a perspective view of the cover of FIG. 5A in accordance with yet another embodiment of the invention; and

FIG. 5C is a front view of a food-item enclosure including the cover of FIG. 5A and a base in accordance with yet another embodiment of the invention.

### DETAILED DESCRIPTION

Example apparatus are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

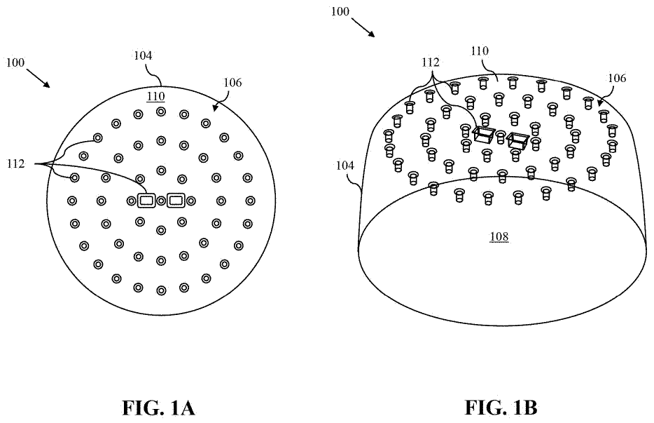

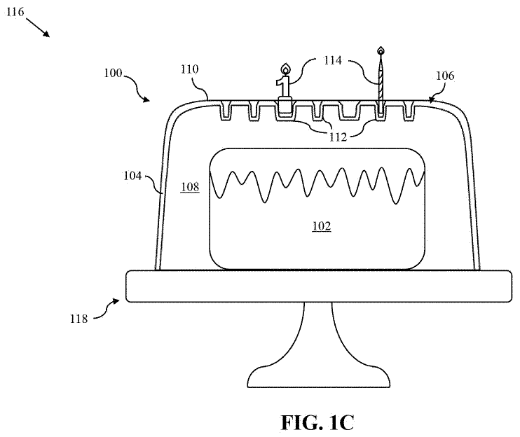

FIG. IA is a top view of a cover 100 for a food item, such as a cake, in accordance with an embodiment of the invention. FIG. 1B is a perspective view of the cover 100 in accordance with an embodiment of the invention.

The cover 100 (i.e., a germ protector) for a food item includes a sidewall 104 and a top 106. As shown in FIGS. 1A and 1B, the cover 100 has a circular shape. The sidewall 104 runs around a perimeter of the cover 100. The top 106 is integrally coupled to the sidewall 104. In one embodiment, the sidewall 104 and the top 106 are molded separately and after molding are integrally coupled with each other. In another embodiment, the sidewall 104 and the top 106 are molded together such that, the sidewall 104 and the top 106 are integrally coupled with each other upon molding. In another embodiment, the cover is vacuum formed.

The top 106 together with the sidewall 104 forms an interior space, shown as reference 108 in FIG. 1B, to enclose a food item located therein. The top 106 includes an upper surface 110 having one or more features 112 to secure one or more candles to the top 106. The one or more features 112 are at least one of a recess and a protrusion. In the embodiment shown in FIGS. 1A and 1B the one or more features 112 are recesses formed on the upper surface 110 of the top 106. The one or more features 112 have at least one of a circular shape and a rectangular shape. In one example, the one or more features 112 are defined by at least one of a length, a width, a depth, a height, and a diameter.

It will be apparent to a person skilled in the art that although in the embodiment of FIGS. 1A and 1B the one or more features 112 have circular and rectangular shapes, the scope of the present disclosure is not limited to it. In various other embodiments, the one or more features 112 may have any shape that is capable of securing the one or more candles to the top 106, without deviating from the scope of the present invention.

FIG. 1C is a front view of a food-item enclosure 116 including a cover 100 and a base 118 in accordance with an embodiment of the invention. The base 118 is configured to support a food item 102. The cover 100 is positioned on top of the base 118.

As shown in FIG. 1C, the food item 102 (herein, the cake) is located within the interior space 108 formed by the sidewall 104, the top 106, the base 118. The interior space 108 is configured to enclose the food item 102 located on the base 118. The one or more candles 114 are inserted in respective features of the one or more features 112 on the upper surface 110 of the top 106, thereby securing the one or more candles 114 to the top 106. In one embodiment, the one or more candles 114 may be at least one of stick candles with a circular bottom shape or number candles with a rectangular bottom shape. The stick candle of the one or more candles 114 with the circular bottom shape is inserted into a respective feature of the one or more features 112 that has a circular shape, and the number candle with the rectangular bottom shape are inserted into a respective feature of the one or more features 112 that has a rectangular shape.

It will be apparent to a person skilled in the art that although in the current embodiment, the upper surface 110 of the top 106 includes the one or more features 112 to secure the one or more candles 114 to the top 106, the scope of the present invention is not limited to it. In various other embodiments, the upper surface 110 of the top 106 may include the one or more features 112 to secure one or more decorative elements used in special occasions to the top 106, without deviating from the scope of the present invention.

The cover 100 is configured to protect the food item 102 from airborne contamination released by a person while blowing out the one or more candles 114.

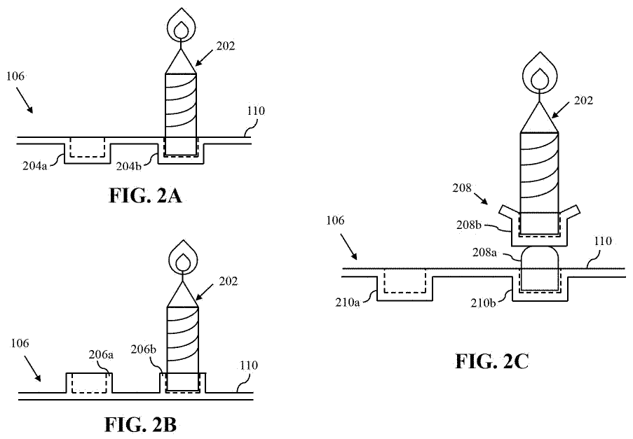

FIG. 2A is a diagram illustrating a candle 202 secured to the top 106 of the cover 100 in accordance with an embodiment of the present invention. In the embodiment, the upper surface 110 of the top 106 includes first and second features 204a and 204b to secure the one or more candles to the top 106. The first and second features 204a and 204b are recesses and may have at least one of a circular shape and a rectangular shape. In one example, the first and second features 204a and 204b have the circular shape. The candle 202 of the one or more candles is a stick candle having a circular bottom shape and is inserted in the second feature 204b, thereby the candle 202 is secured to the top 106 of the cover 100.

FIG. 2B is a diagram illustrating the candle 202 secured to the top 106 of the cover 100 in accordance with another embodiment of the invention. In the embodiment, the upper surface 110 of the top 106 includes third and fourth features 206a and 206b to secure the one or more candles to the top 106. The third and fourth features 206a and 206b are protrusions and may have at least one of a circular shape and a rectangular shape. In one example, the third and fourth features 206a and 206b have the circular shape. The candle 202 is a stick candle having a circular bottom shape and is inserted in the fourth feature 206b, thereby the candle 202 is secured to the top 106 of the cover 100.

FIG. 2C is a diagram illustrating the candle 202 secured to the top 106 of the cover 100 by way of a candle adaptor 208 in accordance with an embodiment of the invention. The candle adaptor 208 is used between the cover 100 and the candle 202 to secure the candle 202 to the top 106 of the cover 100.

In the embodiment of FIG. 2C, the upper surface 110 of the top 106 includes fifth and sixth features 210a and 210b to receive a candle adaptor, such as the candle adaptor 208. The fifth and sixth features 210a and 210b are recesses and have a shape, such as a circular or rectangular shape, that is capable of receiving the candle adaptor 208 and securing the candle adaptor 208 to the top 106. The candle adaptor 208 has a bottom portion 208a to engage with the sixth feature 210b on the upper surface 110 of the top 106, and a top portion 208b to receive the candle 202. The top portion 208b has a shape that is capable of receiving the candle 202 and thereby securing the candle 202 to the top 106. Thus, by using the candle adaptor 208, the cover 100 may be designed with only one type of recess, for example, a recess having a circular shape, such that the candle adaptor 208 is configured to receive a candle having any bottom shape, e.g., circular or rectangular.

It will be apparent to a person skilled in the art that although in the embodiment in FIG. 2C the fifth and sixth features 210a and 210b are recesses and have a shape that is capable of receiving the candle adaptor 208 and securing the candle adaptor 208 to the top 106, the scope of the present invention is not limited to it. In various other embodiments, the fifth and sixth features 210a and 210b may be protrusions and have a shape that is capable of receiving the candle adaptor 208 and securing the candle adaptor 208 to the top 106, without deviating from the scope of the present invention.

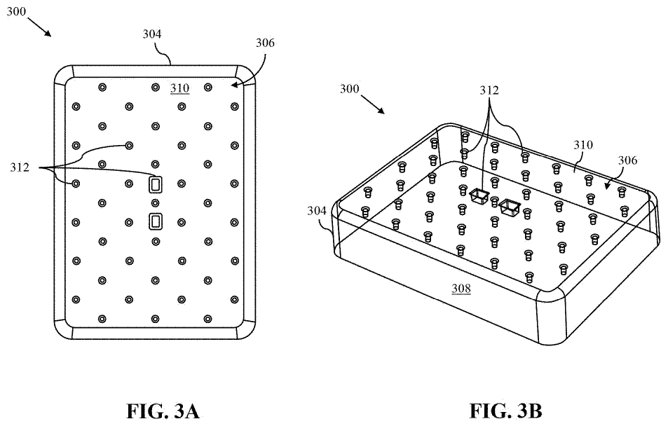

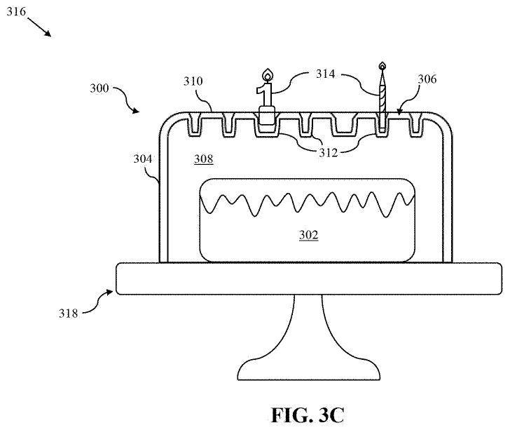

FIG. 3A is a top view of a cover 300 for a food item in accordance with another embodiment of the invention. FIG. 3B is a perspective view of the cover of FIG. 3A in accordance with another embodiment of the invention

The cover 300 (i.e., a germ protector) for the food item underneath includes a sidewall 304 and a top 306. As shown in FIGS. 3A and 3B, the cover 300 has a rectangular shape. The sidewall 304 runs around a perimeter of the cover 300. The top 306 is integrally coupled to the sidewall 304. In one embodiment, the sidewall 304 and the top 306 are molded separately and then integrally coupled with each other. In another embodiment, the sidewall 304 and the top 306 are molded together such that the sidewall 304 and the top 306 are integrally coupled with each other upon molding.

The top 306 together with the sidewall 304 forms an interior space 308 to enclose the food item located therein. The top 306 includes an upper surface 310 having one or more features 312 to secure one or more candles to the top 306. The one or more features 312 are at least one of a recess and a protrusion. In the embodiment in FIGS. 3A and 3B, the one or more features 312 are recesses formed on the upper surface 310 of the top 306. In one example, the one or more features 312 are defined by at least one of a length, a width, a depth, a height, and a diameter. The one or more features 312 have at least one of a circular shape and a rectangular shape.

FIG. 3C is a front view of a food-item enclosure 316 including the cover 300 and a base 318 enclosing the food item 302 in accordance with another embodiment of the invention. The base 318 is configured to support the food item 302. The cover 300 is positioned on top of the base 318.

As shown in FIG. 3C, the food item 302 (herein, the cake) is located within the interior space 308 formed by the sidewall 304, the top 306, the base 318. The interior space 308 is configured to enclose the food item 302 located on the base 318. The one or more candles 314 are inserted in respective features of the one or more features 312 on the upper surface 310 of the top 306, thereby securing the one or more candles 314 to the top 306. In one embodiment, the one or more candles 314 may be at least one of stick candles with a circular bottom shape or number candles with a rectangular bottom shape. The stick candle of the one or more candles 314 with the circular bottom shape is inserted into a respective feature of the one or more features 312 that has a circular shape, and the number candle with the rectangular bottom shape are inserted into a respective feature of the one or more features 312 that has a rectangular shape.

It will be apparent to a person skilled in the art that the one or more candles 314 may be secured to the top 306 by way of one or more candle adaptors, such as the candle adapter 208 in FIG. 2C, in a manner similar to securing of the candle 202 to the top 106 as shown in FIG. 2C. The one or more candle adaptors would have a bottom portion to engage with the one or more features 312 on the upper surface 310 of the top 306, and a top portion to receive the one or more candles 314. The cover 300 is configured to protect the food item 302 from airborne contamination released by a person while blowing out the one or more candles 314.

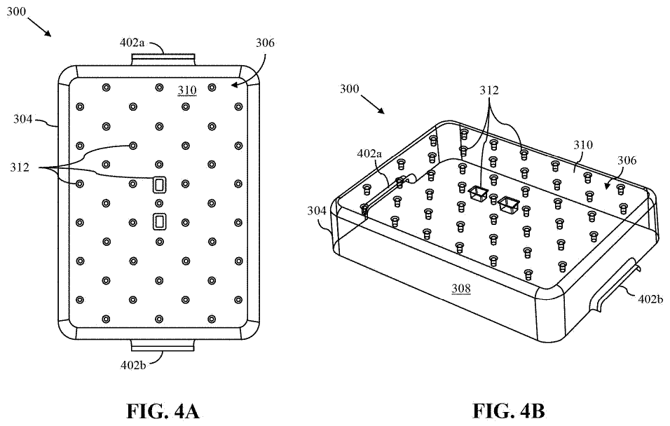

FIG. 4A is a top view of the cover 300 including first and second members 402a and 402b to be grasped for lifting or lowering (e.g., manually) of the cover 300 in accordance with an embodiment of the invention. FIG. 4B is a perspective view of the cover 300 in FIG. 4A including the first and second members 402a and 402b to be grasped for manual lifting or lowering of the cover 300 in accordance with an embodiment of the invention.

The sidewall 304 includes the first and second members 402a and 402b that are configured to be grasped during lifting and lowering of the cover 300. The first and second members 402a and 402b are on opposite sides of the sidewall 304. The first and second members 402a and 402b are one of a recess, a protrusion, and a handle. In the current embodiment. the first and second members 402a and 402b are protrusions. However, the scope of the present disclosure is not limited to it, and in various other embodiments the first and second members 402a and 402b may be recesses or handles.

It will be apparent to a person skilled in the art that although in the current embodiment, the sidewall 304 includes the first and second members 402a and 402b, the scope of the present disclosure is not limited to it. In various other embodiments, the top 306 includes the first and second members 402a and 402b that are configured to be grasped during lifting and lowering (e.g., manual lifting and lowering) of the cover 300. In an example, the cover 300 may include one of a recess, a protrusion, and a handle at a center of the upper surface 310 of the top 306.

It will further be understood by a person skilled in the art that in one embodiment, the cover 300 may also include an at least one member, such as the first or second member 402a or 402b, on the sidewall 304 or the top 306 of the cover 300, such that the at least one member is configured to be grasped during manual lifting and lowering of the cover 300.

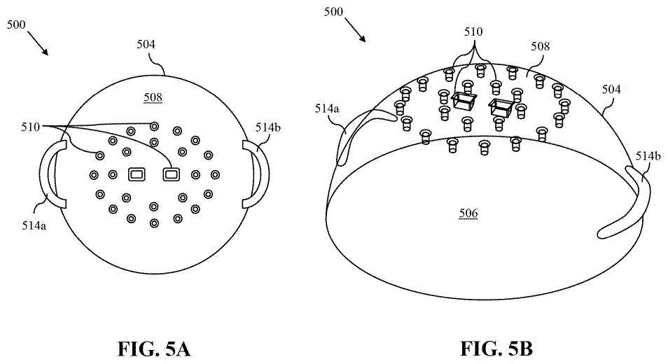

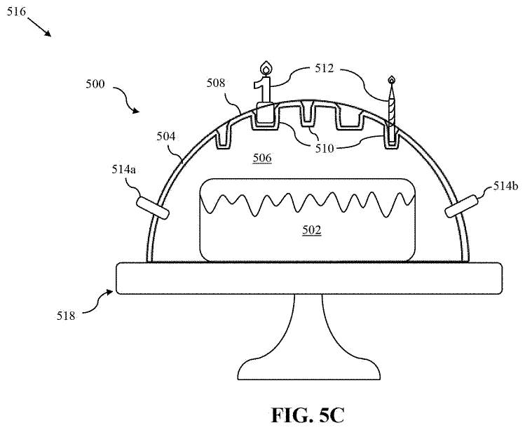

FIG. 5A is a top view of a cover 500 for a food item in accordance with yet another embodiment of the present invention. FIG. 5B is a perspective view of the cover 500 in FIG. 5A.

The cover 500 (i.e., a germ protector) for a food item includes a curved wall 504 forming an interior space 506 to enclose the food item 502 located therein. As shown in FIGS. 5A and 5B, the cover 500 has a hemispherical (or dome) shape. The curved wall 504 includes an upper surface 508 having one or more features 510 to secure one or more candles to the upper surface 508. The one or more features 510 are at least one of a recess and a protrusion. In the embodiment of FIGS. 5A and 5B the one or more features 510 are recesses formed on the upper surface 508 of the curved wall 504. In one example, the one or more features 510 are defined by at least one of a length, a width, a depth, a height, and a diameter. The one or more features 510 have at least one of a circular shape and a rectangular shape.

The curved wall 504 includes first and second members 514a and 514b that are configured to be grasped during lifting and lowering (e.g., manual lifting and lowering) of the cover 500. The first and second members 514a and 514b are one of a recess, a protrusion, and a handle. in the current embodiment, the first and second members 514a and 514b are handles attached to the curved wall 504.

FIG. 5C is a front view of a food-item enclosure 516 including the cover 500 and a base 518 in accordance with yet another embodiment of the present disclosure. The base 518 is configured to support the food item 502. The cover 500 is positioned on top of the base 518.

As shown in FIG. SC, the food item 502 (herein, the cake) is located within the interior space 506 formed by the curved wall 504 and the base 518. The interior space 506 is configured to enclose the food item 502 located on the base 518. The one or more candles 512 are inserted in respective features of the one or more features 510 on the upper surface 508 of the curved wall 504, thereby securing the one or more candles 512 to the upper surface 508. In one embodiment, the one or more candles 512 may be at least one of stick candles with a circular bottom shape or number candles with a rectangular bottom shape. The stick candle of the one or more candles 512 with the circular bottom shape is inserted into a respective feature of the one or more features 510 that has a circular shape, and the number candle of the one or more candles 512 with the rectangular bottom shape are inserted into a respective feature of the one or more features 510 that has a rectangular shape.

It will be apparent to a person skilled in the art that the one or more candles 512 may be secured to the upper surface 508 by way of one or more candle adaptors, such as the candle adapter 208 in FIG. 2C, in a manner similar to securing of the candle 202 to the top 106 as shown in FIG. 2C. The one or more candle adaptors would have a bottom portion to engage with the one or more features 510 on the upper surface 508 of the curved wall 504, and a top portion to receive the one or more candles 512. The cover 500 is configured to protect the food item 502 from airborne contamination released by a person while blowing out the one or more candles 512.

The covers 100, 300, and 500 are shown with open bottoms, such that the covers 100, 300, and 500 may be lowered over the food items 102, 302, and 502, and rest on the bases 118, 318, and 518 that support the food items 102, 302, and 502, respectively. The bases 118, 318, and 518 are one of a plate, a tray, or a countertop, or a table top.

The covers 100, 300, and 500 are preferably made of a plastic material. The plastic material is at least one of a substantially rigid, transparent, fire retardant, and dishwasher safe. As used herein, the term substantially rigid refers to a property of the material that allows insertion a candle to be inserted into the recess or the protrusion feature without the cover deforming and losing its original shape. As wall thickness of the cover is increased, the required level of rigidity of the material is lowered.

It will be apparent to a person skilled in the art that although in the current embodiment. the covers 100 in FIGS. IA through IC, 300 in FIGS. 3A through 3C, and 500 in FIGS. 5A through 5C are made of the plastic material that is at least one of substantially rigid, transparent, fire retardant, and dishwasher safe, in various other embodiments, the covers 100 in 300, and 500 may be made of any other material, such as glass, with similar properties, without deviating from the scope of the present disclosure. Moreover, in some embodiments, the sidewalls of the covers 100 and 300 may be mate of metal, such as stainless steel, aluminum, etc. Furthermore. the invented cover may include artistic coloring and profiling for aesthetic purposes.

In one embodiment, the food items 102, 302, and 502 are desserts, more preferably, cakes. It will be apparent to a person skilled in the art that although in the current embodiment, the food items 102, 302, and 502 are desserts (herein, the cakes), in various other embodiments, the food items 102, 302, and 502 may be any food item that needs to be protected from germs, without deviating from the scope of the present disclosure.

In one preferred embodiment of the disclosure the covers 100, 300, and 500 are made of the plastic material, such as a substantially rigid plastic material, and more preferably, a transparent rigid plastic material that is fire retardant and dishwasher safe, so as not to be damaged by household dish detergents. In one embodiment, the material may be clear fiberglass or polypropylene with a wail thickness from about 0.02 inches to about 0.05 inches.

It will be apparent to a person skilled in the art that although in the aforementioned embodiments, the covers 100, 300, and 500 have circular, rectangular, and hemispherical shapes, respectively, the scope of the present invention is not so limited. As a result, in various other embodiments, the covers 100, 300, and 500 may be of any shape capable of enclosing the food items 102, 302, and 502, respectively, without deviating from the scope of the present disclosure.

Once a cover, such as the cover 100 in FIGS. 1A through 1C, with one or more candles, such as the one or more candies 114, inserted therein, is placed over the food item, such as the food item 102 (herein, the cake), and the one or more candles are lit, the person to whom the cake is presented may blow out the one or more candles without contaminating the cake. Thus, with the cover in place, while blowing out the one or more candles, the surface of the cake is protected from being sprayed with germs, viruses, such as the COVID-19 virus, or bacteria. and the people consuming the cake are protected from being infected.

To reduce storage space when not in use, present invention also contemplates that two or more covers of the same shape could be designed to be stackable, one on top of the other. As a result, in one embodiment, the sidewalls of the cover would have a slight taper, e.g., sidewall 104 in FIG. 1C, allowing the 100 cover to be stacked on top of another cover 100 for storage.

Although the disclosure is described herein with reference to specific embodiments, various modifications and changes can be made without departing from the scope of the present disclosure as set forth in the claims below. Accordingly, the specification and figures are to be regarded in an illustrative rather than a restrictive sense, and all such modifications are intended to be included within the scope of the present disclosure. Any benefits, advantages, or solutions to problems that are described herein with regard to specific embodiments are not intended to be construed as a critical. required, or essential feature or element of any or all the claims.

The term “coupled”, as used herein, is not intended to be limited to a direct coupling or a mechanical coupling.

Unless stated otherwise, terms such as “first” and “second” are used to arbitrarily distinguish between the elements such terms describe. Thus, these terms are not necessarily intended to indicate temporal or other prioritization of such elements.

Unless otherwise stated, conditional languages such as “can”, “could”, “will”, “might”, or “may” are understood within the context as used in general to convey that certain embodiments include, while other embodiments do not include, certain features and/or elements. Thus, such conditional languages are not generally intended to imply that features and/or elements are in any way required for one or more embodiments.

It will be understood by those within the art that, in general, terms used herein, are generally intended as “open” terms (e.g., the term “including” should be interpreted as “including but not limited to”, the term “having” should be interpreted as “having at least”, the term “includes” should be interpreted as “includes but is not limited to”, etc.).

1. A cover comprising:
a sidewall; and
a top integrally coupled to the sidewall and together with the sidewall forming an interior space to enclose a food item located therein,
wherein the top comprises an upper surface having a feature configured to secure a candle to the top, and
wherein the cover is configured to protect the food item from airborne contamination released by a person while blowing out the candle.

2. The cover of claim 1, wherein the cover is made of a plastic material.

3. The cover of claim 2, wherein the plastic material has an at least one of rigid, transparent. fire retardant, and dishwasher safe property.

4. The cover of claim 1, wherein the feature is at least one of a recess and a protrusion.

5. The cover of claim 1, wherein the feature has at least one of a circular shape and a rectangular shape.

6. The cover of claim 1, wherein the candle is secured on the top by way of a candle adaptor having a bottom portion to engage with the feature on the upper surface of the top, and a top portion to receive the candle.

7. The cover of claim 1, wherein the sidewall includes an at least one member configured to be grasped during manual lifting and lowering of the cover.

8. The cover of claim 7, wherein the at least one member is one of a recess, a protrusion, and a handle.

9. The cover of claim 1, wherein the top includes an at least one member configured to be grasped during manual lifting and lowering of the cover.

10. The cover of claim 9, wherein the at least one member is one of a recess, a protrusion, and a handle.

11. A cover for a food item, the cover comprising:
a curved wall forming an interior space to enclose the food item located therein, the curved wall comprising an upper surface having a feature to secure a candle to the upper surface,
wherein the cover is configured to protect the food item from airborne contamination released by a person while blowing out the candle.

12. The cover of claim 11, wherein the cover is made of a plastic material.

13. The cover of claim 12, wherein the plastic material has an at least one of rigid, transparent, fire retardant, and dishwasher safe property.

14. The cover of claim 11, wherein the feature is at least one of a recess and a protrusion.

15. The cover of claim 11, wherein the feature has at least one of a circular shape and a rectangular shape.

16. The cover of claim 11, wherein the candle is secured on the upper surface by way of a candle adaptor having a bottom portion to engage with the feature on the upper surface of the curved wall, and a top portion to receive the candle.

17. The cover of claim 11, wherein the curved wall includes an at least one member configured to be grasped during manual lifting and lowering of the cover.

18. The cover of claim 17, wherein the at least one member is one of a recess, a protrusion, and a handle.

19. A food-item enclosure comprising:
a base configured to support a food item; and
a cover positioned on top of the base, the cover comprising a top integrally coupled to a sidewall and together with the base forming an interior space configured to enclose the food item located on the base,
wherein the top comprises an upper surface having a feature to secure a candle to the top;
wherein the cover is made of a plastic material that is at least one of rigid, transparent, fire retardant, and dishwasher safe; and
wherein the cover is configured to protect the food item from airborne contamination released by a person while blowing out the candle.

20. The food-item enclosure of claim 19, wherein the feature is at least one of a recess and a protrusion, and wherein the feature has at least one of a circular shape and a rectangular shape.
